(19) United States
(12) Patent Application Publication
(10) Pub. No.: US 2026/0003221 A1
(43) Pub. Date: Jan. 1, 2026

(54) DISPLAY DEVICE

(71) Applicant: Sharp Display Technology Corporation, Kameyama City (JP)

(72) Inventors: Mariko HONDA, Kameyama City (JP); Shinji SHIMADA, Kameyama City (JP); Koji MURATA, Kameyama City (JP); Kimiaki NAKAMURA, Kameyama City (JP); Kazutaka HANAOKA, Kameyama City (JP); Atsuko KANASHIMA, Kameyama City (JP); Yasuhiro HASEBA, Kameyama City (JP)

(21) Appl. No.: 19/243,797

(22) Filed: Jun. 20, 2025

(30) Foreign Application Priority Data
Jun. 28, 2024 (JP) 2024-105315

(51) Int. Cl. G02F 1/1334; G02F 1/13357

(52) U.S. Cl. CPC G02F 1/1334; G02F 1/133603; G02F 2201/56

(57) ABSTRACT

The display device includes: a liquid crystal panel including a pair of substrates and a polymer dispersed liquid crystal layer held between the pair of substrates; and a light source disposed on a back surface side of the liquid crystal panel. The liquid crystal panel is curved such that a center in a curving direction along a surface of the liquid crystal panel protrudes toward a front surface side or the back surface side of the liquid crystal panel relative to two end portions in the curving direction. The light source is disposed, in a plan view, along at least one of the two end portions of the liquid crystal panel extending in a direction perpendicular to the curving direction. The liquid crystal panel has a curvature of 1/(W₁×40) or more and 1/(W₁×1.25) or less.

### CROSS-REFERENCE TO RELATED APPLICATIONS

The present application claims priority under 35 U.S.C. § 119 to Japanese Patent Application No. 2024-105315 filed on Jun. 28, 2024, the contents of which are incorporated herein by reference in their entirety.

### BACKGROUND OF THE INVENTION

### Field of the Invention

The disclosure relates to display devices.

### Description of Related Art

Liquid crystal display devices are display devices utilizing a liquid crystal composition to display images. Typical display methods thereof include applying voltage to the liquid crystal composition sealed between a pair of substrates to change the alignment of liquid crystal components in the liquid crystal composition based on the applied voltage, thus controlling the amount of light passing through the liquid crystal display device. Such liquid crystal display devices are used in a variety of fields owing to their features including their thin profile, light weight, and low power consumption.

See-through displays have drawn attention which are capable of providing display where the background of their liquid crystal display device can be seen through the device. Liquid crystal display devices using a polymer dispersed liquid crystal (PDLC) material have been developed as liquid crystal display devices for see-through displays. A PDLC material contains liquid crystal components dispersed in a polymer network. Application of voltage to the PDLC material changes the alignment of the liquid crystal components and produces a difference in refractive index between the liquid crystal components and the polymer network. The liquid crystal display devices use this difference to switch between a transparent state and a scattering state.

For example, JP 2019-032411 A discloses a display device including: a display panel including a first substrate, a second substrate which is opposed to the first substrate, and a polymer dispersed liquid crystal layer which is held between the first substrate and the second substrate and contains a polymer and a liquid crystal molecule; a light emitting element; a light guide layer having a first surface which is opposed to the display panel, and an edge which is opposed to the light emitting element; and a first optical layer located between the display panel and the light guide layer, wherein a refractive index of the first optical layer is lower than a refractive index of the light guide layer.

### BRIEF SUMMARY OF THE INVENTION

(1) One embodiment of the present invention is directed to a display device including: a liquid crystal panel including a pair of substrates and a polymer dispersed liquid crystal layer held between the pair of substrates; and a light source disposed on a back surface side of the liquid crystal panel, with a space between the light source and the liquid crystal panel, the liquid crystal panel being curved such that a center in a curving direction along a surface of the liquid crystal panel protrudes toward a front surface side of the liquid crystal panel relative to two end portions in the curving direction, the light source being disposed, in a plan view, along at least one of the two end portions of the liquid crystal panel extending in a direction perpendicular to the curving direction, the liquid crystal panel having a curvature of 1/(W₁×40) or more and 1/(W₁×1.25) or less, where W₁ (unit: cm) is a length of the liquid crystal panel along the curving direction.

(2) Another embodiment of the present invention is directed to a display device including: a liquid crystal panel including a pair of substrates and a polymer dispersed liquid crystal layer held between the pair of substrates; and a light source disposed on a back surface side of the liquid crystal panel, with a space between the light source and the liquid crystal panel, the liquid crystal panel being curved such that a center in a curving direction along a surface of the liquid crystal panel protrudes toward the back surface side of the liquid crystal panel relative to two end portions in the curving direction, the light source being disposed, in a plan view, along at least one of the two end portions of the liquid crystal panel extending in a direction perpendicular to the curving direction, the liquid crystal panel having a curvature of 1/(W₁×40) or more and 1/(W₁×1.25) or less, where W₁ (unit: cm) is a length of the liquid crystal panel along the curving direction.

(3) In an embodiment of the present invention, the display device includes the structure (1) or (2), and the light source is configured to emit light in an oblique direction relative to a surface of the liquid crystal panel.

(4) In an embodiment of the present invention, the display device includes any one of the structures (1) to (3), and an irradiation angle of light from the light source that is incident on the center of the liquid crystal panel is 54.0° or more and 76.0° or less.

(5) In an embodiment of the present invention, the display device includes the structure (4), and the liquid crystal panel has a curvature of 1/(W₁×25) or more and 1/(W₁×1.25) or less.

(6) In an embodiment of the present invention, the display device includes the structure (2) or (3), and an irradiation angle of light from the light source that is incident on the center of the liquid crystal panel is 60.0° or more and 70.0° or less.

(7) In an embodiment of the present invention, the display device includes any one of the structures (1) to (3), the liquid crystal panel has a curvature of 1/(W₁×13.75) or more and 1/(W₁×1.25) or less, and an irradiation angle of light from the light source that is incident on the center of the liquid crystal panel is 54.0° or more and 75.0° or less.

(8) In an embodiment of the present invention, the display device includes any one of the structures (1) to (3), the liquid crystal panel has a curvature of 1/(W₁×5) or more and 1/(W₁×1.25) or less, and an irradiation angle of light from the light source that is incident on the center of the liquid crystal panel is 54.0° or more and 73.5° or less.

(9) In an embodiment of the present invention, the display device includes any one of the structures (1) to (3), the liquid crystal panel has a curvature of 1/(W₁×2.5) or more and 1/(W₁×1.25) or less, and an irradiation angle of light from the light source that is incident on the center of the liquid crystal panel is 54.0° or more and 71.0° or less.

(10) In an embodiment of the present invention, the display device includes any one of the structures (1) to (3), the liquid crystal panel has a curvature of 1/(W₁×2) or more and 1/(W₁×1.25) or less, and an irradiation angle of light from the light source that is incident on the center of the liquid crystal panel is 54.0° or more and 70.0° or less.

(11) In an embodiment of the present invention, the display device includes any one of the structures (1) to (3), and a distance d₁ from the light source to the liquid crystal panel is 1/10 or more and ⅓ or less of the W₁.

(12) In an embodiment of the present invention, the display device includes any one of the structures (1) to (11), and the display device further comprises a display panel disposed rearward of the back surface side of the liquid crystal panel.

(13) In an embodiment of the present invention, the display device includes the structure (12), and the display panel is curved to protrude toward the liquid crystal panel.

(14) In an embodiment of the present invention, the display device includes the structure (12), and the display panel is curved to protrude toward a side opposite to the liquid crystal panel.

### BRIEF DESCRIPTION OF THE DRAWINGS

FIG. 1 is a schematic cross-sectional view of an example display device of Embodiment 1.

FIG. 2 is a schematic plan view of the display device in FIG. 1.

FIG. 3 is a schematic cross-sectional view of a liquid crystal panel illustrating a method for measuring an irradiation angle.

FIG. 4 is a schematic cross-sectional view illustrating the irradiation angle relative to a predetermined position from an end portion of the liquid crystal panel in Embodiment 1 in which the liquid crystal panel is bent toward the front surface.

FIG. 5 is a schematic cross-sectional view illustrating the transparent state of a polymer dispersed liquid crystal layer.

FIG. 6 is a schematic cross-sectional view illustrating the scattering state of the polymer dispersed liquid crystal layer.

FIG. 7 is a graph of angle dependence of polymer dispersed liquid crystal layers.

FIG. 8 is a schematic cross-sectional view of an example display device according to Embodiment 1 including a display panel disposed rearward of the back surface side of the liquid crystal panel.

FIG. 9 is a schematic cross-sectional view of another example display device according to Embodiment 1 including a display panel rearward of the back surface side of the liquid crystal panel.

FIG. 10 is a schematic cross-sectional view of an example display device according to Embodiment 2.

FIG. 11 is a schematic plan view of the display device in FIG. 10.

FIG. 12 is a schematic cross-sectional view illustrating the irradiation angle relative to a predetermined position from an end portion of the liquid crystal panel in Embodiment 2 in which the liquid crystal panel is bent toward the back surface side.

FIG. 13 is a graph of angle dependence of the polymer dispersed liquid crystal layers used in examples and comparative examples.

FIG. 14 is a schematic cross-sectional view illustrating the irradiation angle relative to the center of the liquid crystal panel in Comparative Example 1.

FIG. 15 is a schematic cross-sectional view illustrating the irradiation angle relative to a predetermined position from an end portion of the liquid crystal panel in Comparative Example 1.

### DETAILED DESCRIPTION OF THE INVENTION

Examples of the light source for see-through displays include edge-lit backlights. With an edge-lit backlight, a liquid crystal display device can be reduced in thickness. Examples of the edge-lit backlight include light-guiding type backlights using a light guide plate. The light-guiding type backlights using a light guide plate have a light source on a side surface of the light guide plate. Light emitted from the light source and incident on the side surface of the light guide plate is reflected in the light guide plate multiple times, and then emitted from the front surface.

However, part of the light reflected in the light guide plate is lost due to diffraction by the components of a liquid crystal panel, such as thin film transistors (TFTs). More light is lost at a position farther from the light source, which possibly leads to a decrease in front characteristics such as the luminance at the center of the display screen.

Such a decrease in front characteristics at the center of a display screen is more significant on display screens with a larger area. In addition, part of transmitted light is lost due to scattering also when the light passes through the PDLC material. It is therefore difficult to achieve both an increase in area of the display screen and favorable front characteristics in thin-profile see-through displays.

The present disclosure aims to provide a display device including a liquid crystal panel that includes a polymer dispersed liquid crystal layer capable of achieving a high luminance even with a display screen having an enlarged area.

The present disclosure is described in more detail based on the following embodiment with reference to the drawings. The present invention is not limited to these embodiments.

### Embodiment 1

A display device of Embodiment 1 includes a liquid crystal panel including a pair of substrates and a polymer dispersed liquid crystal layer held between the pair of substrates, and a light source disposed on a back surface side of the liquid crystal panel, with a space between the light source and the liquid crystal panel. The liquid crystal panel is curved such that a center in a curving direction along a surface of the liquid crystal panel protrudes toward a front surface side of the liquid crystal panel relative to two end portions in the curving direction. The light source is disposed, in a plan view, along at least one of the two end portions of the liquid crystal panel extending in a direction perpendicular to the curving direction. The liquid crystal panel has a curvature of 1/(W₁×40) or more and 1/(W₁×1.25) or less, where W₁ (unit: cm) is a length of the liquid crystal panel along the curving direction.

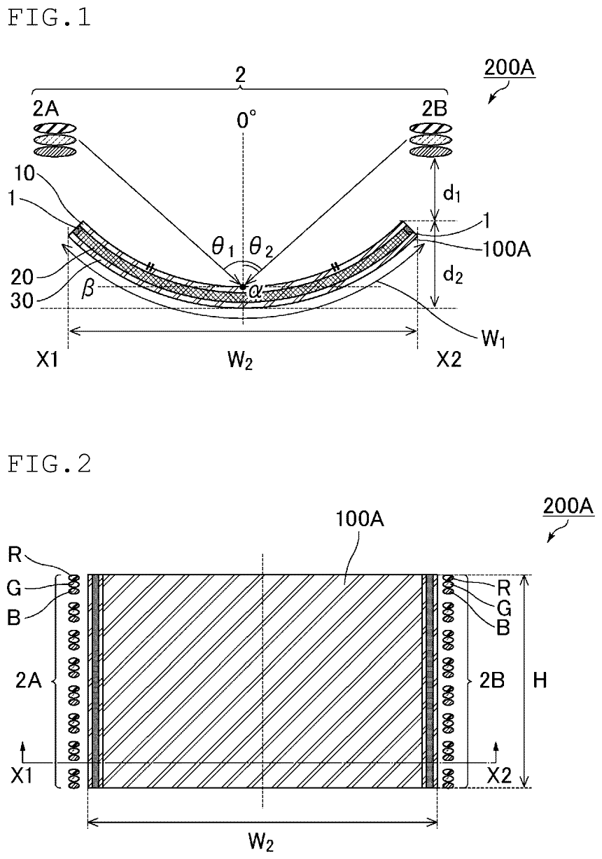

FIG. 1 is a schematic cross-sectional view of an example display device of Embodiment 1. FIG. 2 is a schematic plan view of the display device in FIG. 1. FIG. 1 is a cross-sectional view taken in the curving direction along line X1-X2 in FIG. 2. As shown in FIG. 1, a display device 200A according to Embodiment 1 includes a liquid crystal panel 100A and a light source 2 disposed rearward of the back surface side of the liquid crystal panel 100A. The light source 2 may be, for example, fixed to an enclosure (not shown). Herein, the “front surface side” means a side closer to the observer in front of the display screen of the display device, which is a side closer to the display screen within the display device. The “back surface side” means a side farther from the observer, which is a side farther from the display screen within the display device and is opposite to the front surface side.

The light source 2 is disposed on the back surface side of the liquid crystal panel 100A, with a space between the light source 2 and the liquid crystal panel 100A. In other words, the light source 2 is disposed on the back surface side of the liquid crystal panel 100A via an air layer. Some conventional display devices use an edge-lit backlight with a light guide plate or use an optical clear adhesive (OCA) to attach the liquid crystal panel and the light guide plate together. Light incident on a side surface of the light guide plate from the horizontal direction is reflected inside the light guide plate and emitted toward the liquid crystal panel. The light, however, is sometimes lost when reflected inside the light guide plate or when passing through the OCA, causing a low luminance of the display device. Including the light source 2 disposed with an air layer interposed between the light source 2 and the liquid crystal panel 100A, the display device 200A can achieve a high luminance without reflection inside a conventional light guide plate or loss of light when light passes through the OCA.

A distance d₁ from the light source 2 to the liquid crystal panel 100A is preferably 1/10 or more and ⅓ or less of the later-described length W₁ along the curving direction of the liquid crystal panel 100A. With these values within the ranges above, the difference in luminance between the center and end portions of the liquid crystal panel can be small. The distance d₁ refers to a length of a line extending perpendicularly from a straight line toward the light source 2, the straight line connecting the two ends in the curving direction of the back surface side substrate of the liquid crystal panel 100A.

The d₁ is appropriately selected according to the size and intended use of the display device and is 1 cm or more and 15 cm or less, for example. When the display device 200A is used for an amusement device, the d₁ is preferably 5 cm or more and 10 cm or less. In the case of the later-described FSC driving, the d₁ is preferably 5 cm or more to allow the display device to achieve a sufficient luminance.

The light source 2 is disposed, in a plan view, along at least one of the two end portions of the liquid crystal panel 100A extending in a direction perpendicular to the curving direction of the liquid crystal panel 100A. The light source 2 is preferably disposed in a plan view such that the extending direction of the light source 2 is parallel to at least one of the two end portions of the liquid crystal panel 100A. For example, when the light source 2 includes point light sources such as LEDs, the direction in which the light sources align is preferably parallel to at least one of the two end portions of the liquid crystal panel 100A. When the light source 2 is a rod-like light source such as a linear fluorescent lamp, the light source is preferably disposed such that the longitudinal direction of the light source is parallel to at least one of the two end portions of the liquid crystal panel 100A. The light source 2 only needs to be disposed along at least one of the two end portions of the liquid crystal panel 100A extending in a direction perpendicular to the curving direction. Alternatively, the light source 2 may include a first light source 2A disposed along one of the opposing two end portions and a second light source 2B disposed along the other. FIG. 1 and FIG. 2 show an example in which the liquid crystal panel 100A is a rectangular curved panel that is curved along the long side direction of the liquid crystal panel 100A, and the first light source 2A and the second light source 2B are disposed along the respective opposing short sides of the liquid crystal panel 100A. Herein, the first light source 2A and the second light source 2B are each simply referred to as the light source 2 when no distinction is made therebetween.

When the light source 2 is disposed on the back surface side of the liquid crystal panel 100A, with a space between the light source 2 and the liquid crystal panel 100A, and is disposed, in a plan view, along at least one of the two end portions of the liquid crystal panel 100A extending in a direction perpendicular to the curving direction, light is emitted from the light source 2 in an oblique direction relative to the liquid crystal panel 100A. The expression that light is emitted in an oblique direction relative to the liquid crystal panel 100A means that light emitted from the light source 2 is not parallel to the surface of the liquid crystal panel 100A. This mode in which light is emitted from the light source 2 in an oblique direction relative to the liquid crystal panel 100A can reduce light attenuation and achieve a high luminance at or around the center of the liquid crystal panel, as compared with causing light to be incident on a side surface of the light guide plate as in a conventional edge-lit backlight. The light source 2 preferably emits light in an oblique direction relative to the surface of the liquid crystal panel 100A, and more preferably emits light toward the center in the curving direction of the liquid crystal panel 100A. The light source 2 can be disposed and oriented such that the center of its irradiation range coincides with the center in the curving direction of the liquid crystal panel 100A.

The light source 2 may be of a single color or may include light-emitting elements of multiple colors. Examples of the light-emitting elements include light emitting diodes (LEDs). Preferably, the light-emitting elements emit light isotropically. The light-emitting elements of multiple colors may include, for example, a red light-emitting element R, a green light-emitting element G, and a blue light-emitting element B.

The liquid crystal panel 100A is a curved panel. In Embodiment 1, a case is described where the liquid crystal panel 100A is curved such that the center in the curving direction along its surface protrudes toward the front surface side of the liquid crystal panel 100A relative to the two end portions in the curving direction. With the liquid crystal panel 100A being curved, the angle of incidence of light from the light source 2 that enters the liquid crystal panel 100A can be made small. This can lower the reflectance on the surface of the liquid crystal panel 100A and increase the luminance of the display device 200A.

According to the studies made by the present inventors, when the light source is disposed on the back surface side of a flat liquid crystal panel having no curvature, with a space between the light source and the liquid crystal panel, and is disposed along the end portion(s) of the liquid crystal panel in a plan view, light attenuation inside the panel can be reduced, but the surface reflectance at or around the center of the liquid crystal panel increases, so that the luminance of the display device decreases. For example, as the angle of incidence on the glass substrate (synthetic quartz flat plate (refractive index: 1.458)) increases, the reflectance of the glass substrate surface increases. In other words, when light is emitted from a light source disposed on the back surface side of a flat liquid crystal panel having no curvature, with a space between the light source and the liquid crystal panel, and is disposed, in a plan view, along the end portion(s) of the liquid crystal panel, the angle of incidence on or around the center of the liquid crystal panel is larger than the angle of incidence on or around the end portions of the liquid crystal panel, resulting in a large surface reflectance at or around the center of the liquid crystal panel. This decreases the luminance and contrast ratio of the display device. In contrast, in the present disclosure, the reflectance of the panel surface can be reduced by using a curved panel. In addition, in Embodiment 1, as the curvature of the liquid crystal panel 100A is increased, the difference in luminance between the center and the end portions of the liquid crystal panel can be reduced, so that the luminance and contrast ratio of the whole liquid crystal panel can be improved.

The liquid crystal panel 100A has a curvature of 1/(W₁×40) or more and 1/(W₁×1.25) or less, where W₁ (unit: cm) is the length of the liquid crystal panel 100A along the curving direction of the liquid crystal panel 100A. The W₁ is the length (unit: cm) of the surface of the liquid crystal panel 100A on the front surface side along the curving direction of the liquid crystal panel 100A. With the curvature of the liquid crystal panel set to 1/(W₁×40) or more, the surface reflectance at the center of the liquid crystal panel 100A can be reduced and the luminance of the display device can be increased. In addition, with the curvature of the liquid crystal panel set to 1/(W₁×1.25) or less, poor appearance of the panel due to excessive curving can be reduced or prevented. If the curvature of the liquid crystal panel is set to less than 1/(W₁×40), the surface reflection on the liquid crystal panel 100A cannot be sufficiently reduced. The liquid crystal panel 100A may have a curvature of 1/(W₁×25) or more and 1/(W₁×1.25) or less.

The length W₁ of the liquid crystal panel may be 15 cm or more and 150 cm or less. For example, the length W₁ of a 19-inch liquid crystal panel is 40 cm.

The irradiation angle of light from the light source 2 that is incident on the center of the liquid crystal panel 100A may be 54.0° or more and 76.0° or less. This configuration can effectively increase the luminance at the center of the panel. Hereinbelow, the irradiation angle of light from the light source 2 that is incident on the center of the liquid crystal panel 100A is also referred to as “irradiation angle of the light source 2 relative to the center of the liquid crystal panel 100A”.

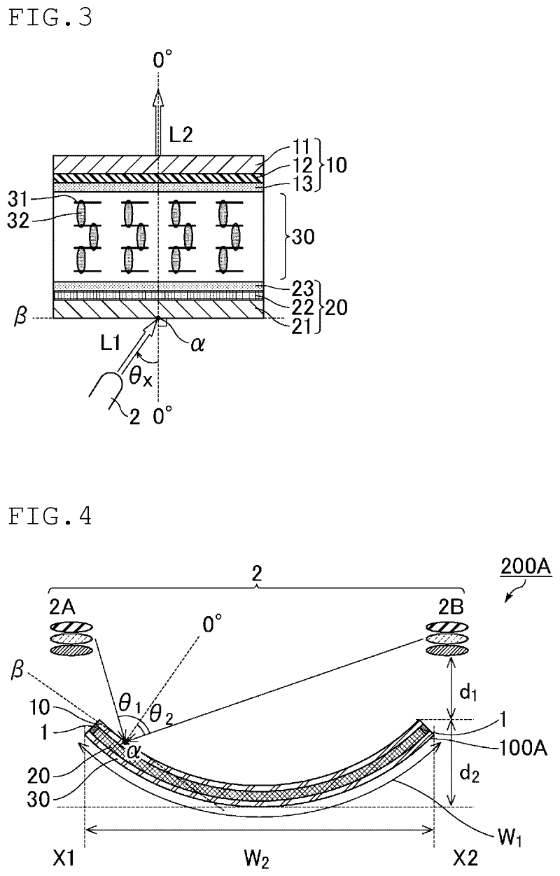

FIG. 3 is a schematic cross-sectional view of a liquid crystal panel illustrating a method for measuring an irradiation angle. As shown in FIG. 3, the direction perpendicular on the light source 2 side to the tangent line β at an arbitrary point α on the surface of the liquid crystal panel 100A on the back surface side in a cross section taken along the curving direction is set as the 0° direction, and the angle between the 0° direction and light from the light source 2 emitted to the back surface of the liquid crystal panel 100A is set as an angle θx. Then, the angle θx corresponds to the irradiation angle of light from the light source that is incident on the arbitrary point α (irradiation angle of the light source relative to the point α) on the liquid crystal panel 100A. Although FIG. 3 shows a flat panel for convenience of description, the substrates 10 and 20 are curved in the embodiment.

In a cross section taken along the curving direction, when the arbitrary point α is the central point in the curving direction of the liquid crystal panel 100A and the direction perpendicular on the light source 2 side to the tangent line β at the point α is set as the 0° direction, the irradiation angle of light from the light source 2 that is incident on the center of the liquid crystal panel 100A is the angle formed between the light emitted from the light source 2 and the 0° direction. The direction of light from the light source 2 that is incident on the center of the liquid crystal panel 100A may be parallel to the curving direction of the liquid crystal panel 100A in a plan view.

When the light source 2 includes the first light source 2A and the second light source 2B, as shown in FIG. 1, the irradiation angle of light from the first light source 2A that is incident on the arbitrary point α is set as θ₁, and the irradiation angle of light from the second light source 2B that is incident on the arbitrary point α is set as θ₂. The irradiation angle θ₁ of light from the first light source 2A that is incident on the center of the liquid crystal panel is equal to the irradiation angle θ₂ of light from the second light source 2B that is incident on the center of the liquid crystal panel. Thus, the irradiation angle of light from the first light source 2A that is incident on the center of the liquid crystal panel 100A (irradiation angle of the first light source 2A relative to the center of the liquid crystal panel 100A) and the irradiation angle of light from the second light source 2B that is incident on the center of the liquid crystal panel 100A (irradiation angle of the second light source 2B relative to the center of the liquid crystal panel 100A) may both be 54.00 or more and 76.00 or less.

The liquid crystal panel 100A may have a curvature of 1/(W₁×13.75) or more and 1/(W₁×1.25) or less. In this case, the irradiation angle relative to the center of the liquid crystal panel 100A may be 54.0° or more and 75.0° or less. When the light source 2 includes the first light source 2A and the second light source 2B, the irradiation angle of the first light source 2A relative to the center of the liquid crystal panel 100A and the irradiation angle of the second light source 2B relative to the center of the liquid crystal panel 100A may both be 54.0° or more and 75.0° or less.

The liquid crystal panel 100A may have a curvature of 1/(W₁×5) or more and 1/(W₁×1.25) or less. In this case, the irradiation angle relative to the center of the liquid crystal panel 100A may be 54.0° or more and 73.5° or less. When the light source 2 includes the first light source 2A and the second light source 2B, the irradiation angle of the first light source 2A relative to the center of the liquid crystal panel 100A and the irradiation angle of the second light source 2B relative to the center of the liquid crystal panel 100A may both be 54.0° or more and 73.5° or less.

The liquid crystal panel 100A may have a curvature of 1/(W₁×2.5) or more and 1/(W₁×1.25) or less. In this case, the irradiation angle relative to the center of the liquid crystal panel 100A may be 54.0° or more and 71.0° or less. When the light source 2 includes the first light source 2A and the second light source 2B, the irradiation angle of the first light source 2A relative to the center of the liquid crystal panel 100A and the irradiation angle of the second light source 2B relative to the center of the liquid crystal panel 100A may both be 54.0° or more and 71.0° or less.

The liquid crystal panel 100A may have a curvature of 1/(W₁×2) or more and 1/(W₁×1.25) or less. In this case, the irradiation angle relative to the center of the liquid crystal panel 100A may be 54.0° or more and 70.0° or less. When the light source 2 includes the first light source 2A and the second light source 2B, the irradiation angle of the first light source 2A relative to the center of the liquid crystal panel 100A and the irradiation angle of the second light source 2B relative to the center of the liquid crystal panel 100A may both be 54.0° or more and 70.0° or less.

FIG. 4 is a schematic cross-sectional view illustrating the irradiation angle relative to a predetermined position from an end portion of the liquid crystal panel in Embodiment 1 in which the liquid crystal panel is bent toward the front surface. An arbitrary point α on the surface of the liquid crystal panel 100A on the back surface side in a cross section taken along the curving direction is set as a predetermined position from an end portion of the liquid crystal panel, and the direction perpendicular on the light source 2 side to the tangent line β at the point α is set as the 0° direction. When the first light source 2A and the second light source 2B are disposed at the two ends of the liquid crystal panel 100A, the irradiation angle refers to the irradiation angle θ₁ or θ₂, whichever is of the light source closer to the point α. Since the light source 2 is disposed on the back surface side of the liquid crystal panel 100A, with a space between the light source 2 and the liquid crystal panel 100A, the angles θ₁ and θ₂ are both more than 0° and less than 90°.

The irradiation angle relative to the ¼ position from an end portion of the liquid crystal panel 100A may be 45° or more and 65° or less. The irradiation angle relative to the ¼ position from an end portion of the liquid crystal panel 100A refers to the irradiation angle relative to a point taken at ¼ of the length W₁ of the liquid crystal panel from the end portion of the liquid crystal panel 100A toward the center of the liquid crystal panel 100A along the curving direction.

In a cross section taken along the curving direction, the irradiation angle relative to a ⅛ position from an end portion of the liquid crystal panel 100A may be 27° or more and 55° or less. The irradiation angle relative to a ⅛ position from an end portion of the liquid crystal panel 100A refers to the irradiation angle relative to a point taken at ⅛ of the length W₁ of the liquid crystal panel from the end portion of the liquid crystal panel 100A toward the center of the liquid crystal panel 100A along the curving direction.

The width W₂ of the liquid crystal panel 100A may be (W₁×0.95) cm or more and less than (W₁×1) cm. The width W₂ is the width of the liquid crystal panel 100A when the liquid crystal panel 100A is projected onto a tangent plane at the center of the surface thereof, which is thus not the actual width of the liquid crystal panel 100A but an apparent panel width with the curvature taken into consideration. The width W₂ is less than the width W₁.

The height H of the liquid crystal panel 100A may be 15 cm or more and 150 cm or less. The height H is the width of the liquid crystal panel 100A in a direction perpendicular to the curving direction in a plan view.

The depth d₂ of the liquid crystal panel 100A may be 1/320 or more and 1/10 or less of the length W₁ of the liquid crystal panel along the curving direction. The depth d₂ is the distance from the two ends in the curving direction of the liquid crystal panel 100A to the tangent plane at the center of the surface of the liquid crystal panel 100A on the front surface side. The depth d₂ of the liquid crystal panel 100A may be 0.1 cm or more and (W₁×0.1) cm or less.

As shown in FIG. 1, the liquid crystal panel 100A includes a pair of substrates 10 and 20 and a polymer dispersed liquid crystal layer 30. The polymer dispersed liquid crystal layer 30 is sandwiched between the pair of substrates 10 and 20. The end portions of the substrates 10 and 20 are sealed by a sealing material 1, and the polymer dispersed liquid crystal layer 30 is surrounded by the sealing material 1 in a plan view.

The polymer dispersed liquid crystal (PDLC) layer 30 contains a polymer network 31 and liquid crystal components 32 dispersed in the polymer network 31. The polymer dispersed liquid crystal layer 30 is controlled to be in a transparent state where the background is seen through the display device with no voltage applied and shift into a scattering state where light emitted from the light source and incident on the polymer dispersed liquid crystal layer 30 is scattered with voltage applied. Such a display method of providing the transparent state with no voltage applied and providing the scattering state with voltage applied is also referred to as a reverse mode. Meanwhile, the display method of providing the scattering state with no voltage applied and providing the transparent state with voltage applied is also referred to as a normal mode. The state “with no voltage applied” means when the voltage applied to the polymer dispersed liquid crystal layer 30 is lower than the threshold voltage of the liquid crystal components (including no voltage application). The state “with voltage applied” means when the voltage applied to the polymer dispersed liquid crystal layer 30 is equal to or higher than the threshold voltage of the liquid crystal components.

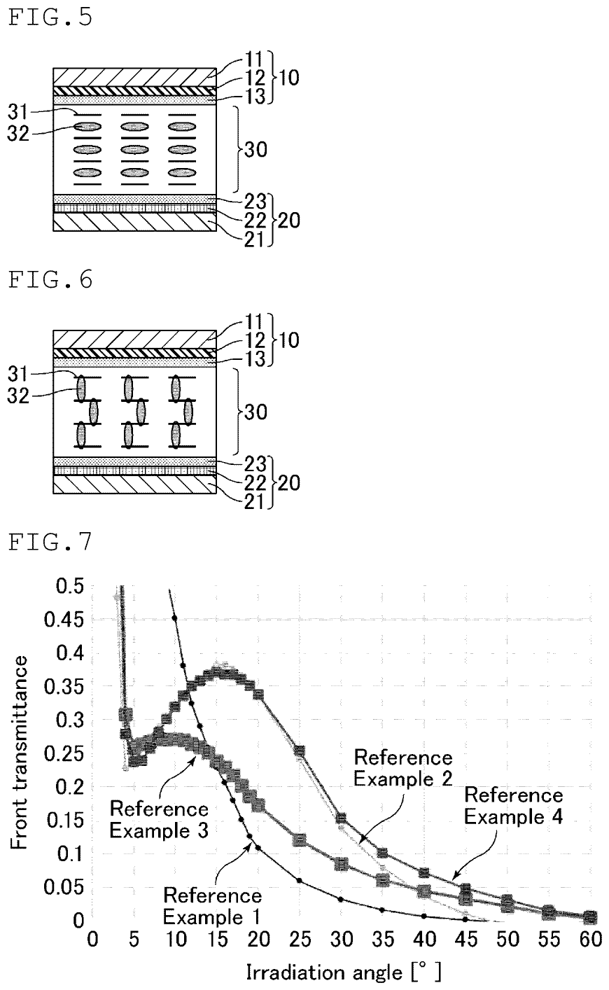

Hereinbelow, the alignment of liquid crystal components in the transparent state and the scattering state is described with reference to FIG. 5 and FIG. 6. FIG. 5 is a schematic cross-sectional view illustrating the transparent state of a polymer dispersed liquid crystal layer. FIG. 6 is a schematic cross-sectional view illustrating the scattering state of the polymer dispersed liquid crystal layer. As shown in FIG. 5 and FIG. 6, the substrates 10 and 20 each preferably include an electrode that applies voltage to the polymer dispersed liquid crystal layer 30. The arrangement of the electrode is not limited. For example, the substrate 10 may include a base material 11, an electrode 12, and an alignment film 13 in the stated order, and the substrate 20 may include a base material 21, an electrode 22, and an alignment film 23 in the stated order.

The base materials 11 and 21 may be, for example, transparent base materials such as glass substrates or plastic substrates. The transparent base materials have a total light transmittance of 90% or higher, for example. Herein, the total light transmittance is measured by a method in conformity with JIS K 7361-1. The total light transmittance can be measured with, for example, the haze meter “Haze Meter NDH2000” available from Nippon Denshoku Industries Co., Ltd.

Preferably, the electrodes 12 and 22 are connected to different power supplies and supplied with different electric potentials. In the case of FIG. 5, voltage applied to the polymer dispersed liquid crystal layer 30 generates a vertical electric field in the thickness direction of the polymer dispersed liquid crystal layer 30 between the electrodes 12 and 22. The electrodes 12 and 22 may be made of, for example, a transparent conductive material such as indium tin oxide (ITO) or indium zinc oxide (IZO).

The alignment film 13 and the alignment film 23 are preferably disposed on the side of the substrate 10 facing the polymer dispersed liquid crystal layer 30 and on the side of the substrate 20 facing the polymer dispersed liquid crystal layer 30, respectively, and are preferably in contact with the polymer dispersed liquid crystal layer 30. The alignment films 13 and 23 control the alignment azimuth of the liquid crystal components 32 dispersed in the polymer network 31 with no voltage applied to the polymer dispersed liquid crystal layer 30. The alignment films 13 and 23 have preferably been subjected to parallel alignment treatment such that, with no voltage applied, the liquid crystal components are in homogeneous alignment in which the long axes of the liquid crystal components are aligned parallel to the surfaces of the substrate 10 and the substrate 20. The alignment films 13 and 23 may be made of any material usually used in the field of liquid crystal display devices, such as an alignment film material for rubbing alignment or an alignment film material for photoalignment.

As shown in FIG. 5, with no voltage applied, preferably, the alignment azimuths of the polymer network 31 and the liquid crystal components 32 are substantially the same as each other. FIG. 5 shows a case where both the polymer network 31 and the liquid crystal components 32 are homogeneously aligned parallel to the surfaces of the substrate 10 and the substrate 20. With no voltage applied, in all directions including the thickness direction of the polymer dispersed liquid crystal layer 30, there is almost no difference in extraordinary refractive index ne between the liquid crystal components 32 and the polymer network 31 and almost no difference in ordinary refractive index no between the liquid crystal components 32 and the polymer network 31. Thus, light emitted from the light source passes through the polymer dispersed liquid crystal layer 30, so that the liquid crystal panel is in the transparent state.

The transparent state is a state of being transparent to light. The polymer dispersed liquid crystal layer 30 in the transparent state may have a transmittance of 80% or higher or 90% or higher. The upper limit of the transmittance of the polymer dispersed liquid crystal layer 30 in the transparent state is, for example, 100%. Herein, the transmittance of the polymer dispersed liquid crystal layer in each of the transparent state and the scattering state is a parallel light transmittance. The parallel light transmittance can be measured with “LCD5200 (photal)” available from Otsuka Electronics Co., Ltd.

As shown in FIG. 6, with voltage applied, the molecules of the polymer network 31 are aligned horizontally to the surfaces of the substrate 10 and the substrate 20, while the liquid crystal components 32 are aligned vertically to the surfaces of the substrate 10 and the substrate 20. With voltage applied, electric fields generated in the polymer dispersed liquid crystal layer 30 change the alignment azimuth of the liquid crystal components 32, while having no influence on the polymer network 31. Thus, in all directions including the thickness direction of the polymer dispersed liquid crystal layer 30, the difference in extraordinary refractive index ne between the liquid crystal components 32 and the polymer network 31 and the difference in ordinary refractive index no between the liquid crystal components 32 and the polymer network 31 are large. Non-polarized light incident on the polymer dispersed liquid crystal layer 30 is scattered without dependence on polarization, so that the polymer dispersed liquid crystal layer 30 is in the scattering state.

The scattering state is a state of scattering light, making the liquid crystal panel appear like frosted glass. The polymer dispersed liquid crystal layer 30 in the scattering state may have a transmittance of 10% or lower or 8% or lower. The lower limit of the transmittance of the polymer dispersed liquid crystal layer 30 in the scattering state is, for example, 0%. The haze showing the light scattering ratio of the polymer dispersed liquid crystal layer 30 in the scattering state varies based on the voltage applied, and may be, for example, 80% or higher or 90% or higher. The upper limit of the haze showing the light scattering ratio of the polymer dispersed liquid crystal layer 30 in the scattering state is, for example, 100%. Herein, the haze is measured by a method in conformity with JIS K 7136. The haze is measured with, for example, the haze meter “Haze Meter NDH2000” available from Nippon Denshoku Industries Co., Ltd. The light may be visible light.

The display device 200A adjusts the amount of light passing through the liquid crystal panel 100A by varying the difference in refractive index ne and the difference in refractive index no between the liquid crystal components 32 and the polymer network 31 in the polymer dispersed liquid crystal layer 30. Thus, the display device requires no polarizing plate required in common liquid crystal panels.

The polymer dispersed liquid crystal layer 30 may have angle dependence. The angle dependence is the property which, in the scattering state, changes the transmittance of light to be emitted from the front surface based on the angle at which light is incident on the back surface side of the polymer dispersed liquid crystal layer 30. The “transmittance of light to be emitted from the front surface” is a parallel light transmittance of the liquid crystal panel at a light acceptance angle of about 3°, and is hereinafter also referred to as a “front transmittance”. A higher front transmittance indicates a higher degree of scattering in the liquid crystal panel 100A as viewed from the front surface side (as observed by the observer), thus meaning that the luminance of the liquid crystal panel 100A in the scattering state is high. The front transmittance was measured with “LCD5200” available from Otsuka Electronics Co., Ltd. For calculation, the transmittance in the state where the light source was turned off and no sample was placed was taken as 0%, and the transmittance in the state where the light source was turned on and a sample was placed was taken as 100%.

### (Examination of Angle Dependence of Polymer Dispersed Liquid Crystal Layer)

The angle dependence of the polymer dispersed liquid crystal layer is described below with reference to FIG. 7. FIG. 7 is a graph of angle dependence of polymer dispersed liquid crystal layers.

The present inventors produced a liquid crystal cell that consists of a polymer dispersed liquid crystal layer having a single structure and having a certain angle dependence to examine the angle dependence of the polymer dispersed liquid crystal layer. For the examination above, a flat liquid crystal cell having no curvature was used. The liquid crystal cell for examination included, as shown in FIG. 3, the polymer dispersed liquid crystal layer 30 containing the polymer network 31 and the liquid crystal components 32, and the pair of substrates 10 and 20 holding the polymer dispersed liquid crystal layer 30 in between. The substrates 10 and 20 respectively included the planar electrodes 12 and 22 and the alignment films 13 and 23 disposed on their polymer dispersed liquid crystal layer 30 side surfaces.

FIG. 3 is also a schematic cross-sectional view illustrating a method of measuring the front transmittance of a polymer dispersed liquid crystal layer. The back surface of the liquid crystal cell was irradiated with light L1 at the irradiation angle θx, and light L2 emitted from the front surface side of the liquid crystal cell was measured to obtain the front transmittance. When the liquid crystal components 32 in the scattering state are aligned in the thickness direction of the polymer dispersed liquid crystal layer 30, i.e., vertically to the surfaces of the substrates 10 and 20, the irradiation angle θx is also regarded as an angle formed by the alignment direction of the liquid crystal components 32 and the irradiation direction of the light.

Liquid crystal cells of the following Reference Examples 1 to 4 were produced to measure the front transmittance and examine the relationship between the irradiation angle and the front transmittance of each cell by the method above. A voltage of 7 V was applied to the polymer dispersed liquid crystal layer to achieve a scattering state. Table 1 summarizes the presence and absence of a chiral agent in Reference Examples 1 to 4 and the anisotropy of refractive index Δn of liquid crystal components.

The polymer dispersed liquid crystal layer of Reference Example 1 includes liquid crystal components, 9% by weight of a polymerizable liquid crystal compound relative to the weight of the liquid crystal components, 5% by weight of a polymerization initiator relative to the weight of the polymerizable liquid crystal compound, and 2% by weight of a chiral agent relative to the total weight of the liquid crystal components, the polymerizable liquid crystal compound, and the polymerization initiator. The polymer dispersed liquid crystal layers of Reference Examples 2 to 4 each include liquid crystal components, 9% by weight of a polymerizable liquid crystal compound relative to the weight of the liquid crystal components, and 5% by weight of a polymerization initiator relative to the weight of the polymerizable liquid crystal compound.

TABLE 1

| | | Δn of Liquid |
|---|---|---|
| | Chiral agent | crystal components |
| Reference Example 1 | Present | 0.14 |
| Reference Example 2 | Absent | 0.14 |
| Reference Example 3 | Absent | 0.18 |
| Reference Example 4 | Absent | 0.22 |

As shown in FIG. 7, changing the Δn of the liquid crystal components enables adjustment of the scattering characteristics (front scattering characteristics) in observation of the liquid crystal panel in the scattering state from front. The front scattering characteristics in the transparent state do not depend on the type of polymer dispersed liquid crystal layer and hardly change regardless of the angle of light incidence. Thus, changing the Δn of the liquid crystal components enables an increase in luminance.

The anisotropy of dielectric constant (Δε) of the liquid crystal components 32 defined by the following formula may be positive or negative, but is preferably positive. More preferably, the anisotropy of dielectric constant of the liquid crystal components 32 is more than 0 and 20 or less. The long axis direction of each liquid crystal component is the slow axis direction.

$$Δ ε = ( dielectric constant in long axis direction ) - ( dielectric constant in short axis direction )$$

The liquid crystal components 32 preferably have an anisotropy of refractive index Δn of 0.14 or higher. The upper limit of the Δn is, for example, 0.28. A higher Δn of the liquid crystal is more preferred, so that the difference in extraordinary refractive index ne between the liquid crystal components 32 and the polymer network 31 and the difference in ordinary refractive index no between the liquid crystal components 32 and the polymer network 31 can be increased. The Δn is preferably 0.16 or higher, more preferably 0.18 or higher. The Δn is particularly preferably 0.18 or higher and 0.22 or lower.

The liquid crystal components 32 preferably have a rotational viscosity γ of 100 mPa's or higher and 400 mPa's or lower. With the γ falling within the range above, the response speed of the liquid crystal components 32 can be high and, in driving of the light source 2 based on the FSC system described below, color mixing can be reduced or prevented. The γ is more preferably 150 mPa·s or higher and 350 mPa·s or lower.

The liquid crystal components 32 can be, for example, a tolan-type liquid crystal material (liquid crystal material having a —C≡C— bond (carbon-carbon triple bond) as a linking group). Specific examples of the tolan-type liquid crystal material include liquid crystal materials having a structure represented by the following formula (L1).

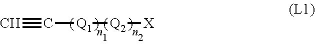

In the formula, Q₁ and Q₂ each independently represent an aromatic ring group, X represents a fluorine group or a cyano group, and n₁ and n₂ each independently represent 0 or 1.

The symbols n₁ and n₂ in the formula (L1) are not 0 at the same time. In other words, the sum of n₁ and n₂ is 1 or 2.

The aromatic ring groups in the formula (L1) may have a substituent.

In the formula (L1), preferably, Q₁ and Q₂ each independently have any one of the structures represented by the following formulas (L2-1) to (L2-7).

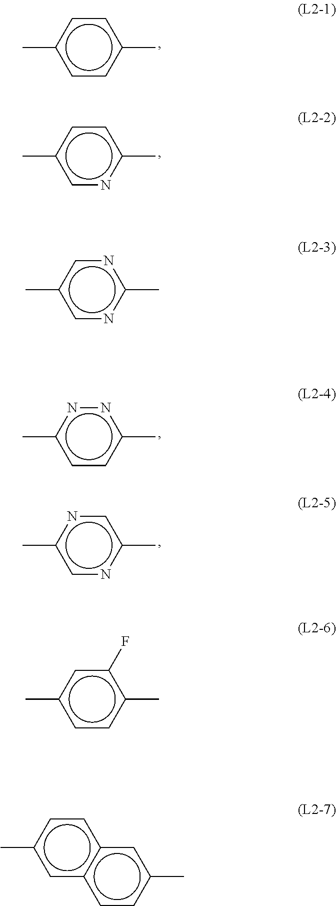

Specific examples of the structure represented by the formula (L1) in the liquid crystal material include the following structures.

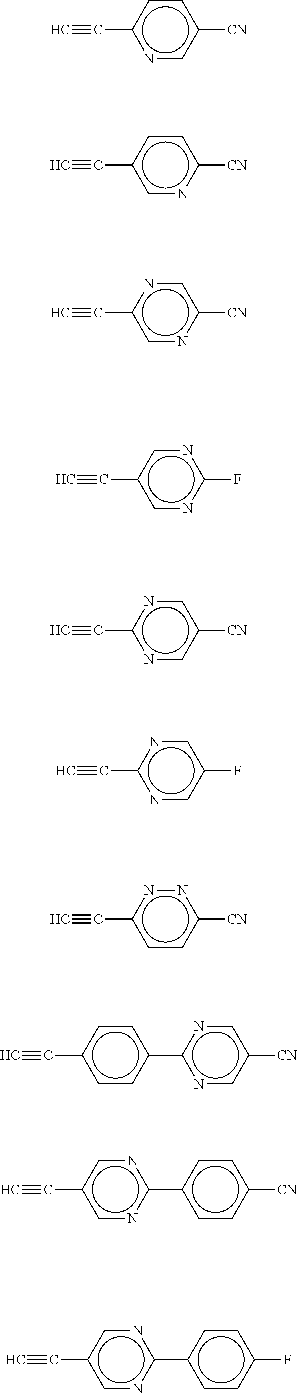

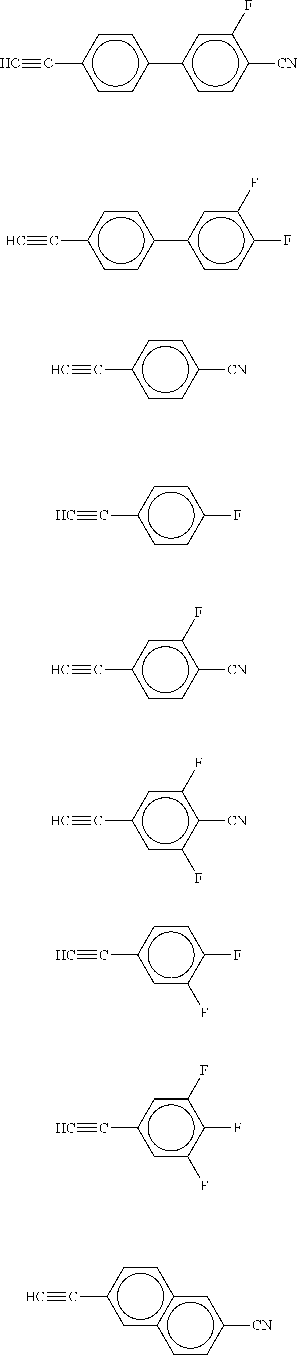

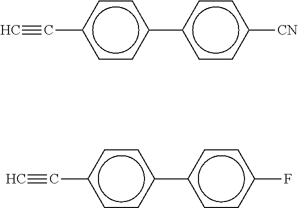

The polymer network 31 is preferably a cured product of a polymerizable liquid crystal compound. The polymer network 31 may define a matrix of three-dimensionally continuous fibers of the cured product, for example. The liquid crystal components 32 are preferably phase-separated and dispersed within the polymer network 31.

In order to increase the transparency of the polymer dispersed liquid crystal layer 30 in the transparent state, preferably, the polymerizable liquid crystal compound defining the polymer network and the liquid crystal components have the same or similar extraordinary refractive index ne and the same or similar ordinary refractive index no, with no voltage applied. For example, the difference in extraordinary refractive index ne and the difference in ordinary refractive index no between the polymerizable liquid crystal compound and the liquid crystal components preferably satisfy Δno, Δne≤0.02, more preferably Δno, Δne≤0.01.

Preferably, the polymerizable liquid crystal compound exhibits a liquid crystal phase at room temperature to form a miscible blend with the liquid crystal components, and is phase-separated from the liquid crystal components after it is cured to form a polymer network. The polymerizable liquid crystal compound may be a photopolymerizable liquid crystal compound curable by ultraviolet light.

Examples of the photopolymerizable liquid crystal compound include monomers having a substituent such as a biphenyl group, a terphenyl group, a naphthalene group, a phenylbenzoate group, an azobenzene group, or a derivative of any of these groups (hereinafter, they are also referred to as mesogen groups); a photoreactive group such as a cinnamoyl group, a chalcone group, a cinnamylidene group, a β-(2-phenyl) acryloyl group, or a derivative of any of these groups; and a polymerizable group such as an acrylate, methacrylate, maleimide, N-phenylmaleimide, or siloxane group. The polymerizable group is preferably an acrylate group. The number of polymerizable groups per molecule of the photopolymerizable liquid crystal compound is not limited, but is preferably 1 or 2. The liquid crystal components may not have a polymerizable group such as an acrylate, methacrylate, maleimide, N-phenyl maleimide, or siloxane group.

The polymer dispersed liquid crystal layer 30 preferably has a polymerizable liquid crystal compound content of 5% by weight or more and 10% by weight or less relative to the weight of the liquid crystal components.

The polymer dispersed liquid crystal layer 30 may contain a polymerization initiator. The polymer dispersed liquid crystal layer 30 preferably has a polymerization initiator content of 5% by weight or more and 10% by weight or less relative to the weight of the polymerizable liquid crystal compound.

The polymerization initiator may be any conventionally known one, such as Omnirad 184® (available from IGM Resins. B.V.) represented by the following chemical formula (IN1) and OXE03 (available from BASF SE) represented by the following chemical formula (IN2).

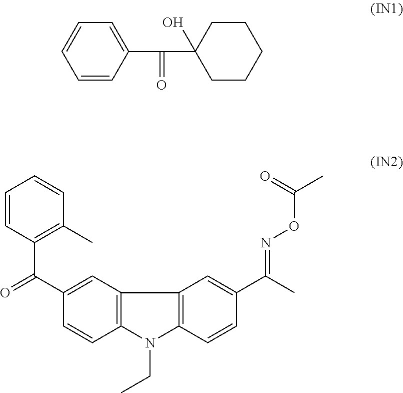 [SMILES: O=C(c1ccccc1)C1(O)CCCCC1 ; CCn1c2ccc(C(=O)c3ccccc3C)cc2c2cc(/C(C)=N/OC(C)=O)ccc21]

The polymer dispersed liquid crystal layer 30 may contain a chiral agent. The polymer dispersed liquid crystal layer 30 preferably has a chiral agent content of 0.5% by weight or more and 48 by weight or less relative to the sum of the weights of the liquid crystal components, the polymerizable liquid crystal compound, and the polymerization initiator.

The chiral agent may be any conventionally known one. The chiral agent can be, for example, CM-51L (available from JNC Corporation) or S-811 (available from Merck KGaA) represented by the following chemical formula (C1).

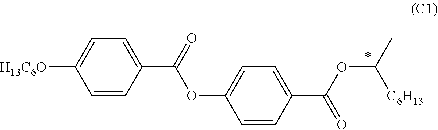

The polymer dispersed liquid crystal layer 30 preferably has a thickness of 3 μm or more and 10 μm or less.

The liquid crystal panel 100A may include pixels arranged in a matrix pattern in a plan view. In this case, the display device 200A can be an active matrix-driven display device. One of the electrodes 12 and 22 may include pixel electrodes arranged in the respective pixels, and each pixel electrode may be controlled to be turned on or off by a switching element such as a TFT disposed in the corresponding pixel. The other of the electrodes 12 and 22 may be, for example, a planar solid electrode, and may be a common electrode supplied with a common electric potential. Both of the electrodes 12 and 22 may be planar solid electrodes without pixels, so that the transmittance of the entire surface of the liquid crystal panel 100A is uniformly controlled. In this case, the display device 200A can be used as a dimmable panel or lighting equipment, for example.

In the display device 200A, the light source 2 may include light-emitting elements of multiple colors, and the light-emitting elements of multiple colors may be driven based on a field-sequential color (FSC) system in which the light-emitting elements are turned on time-divisionally (hereinafter, such driving is also referred to as “FSC driving”). The FSC driving consecutively turns on the light-emitting elements of individual colors at staggered times to provide color display. The FSC-driven color display eliminates the need for color filters, thus enabling display devices with a reduced thickness. Such FSC driving also eliminates the need for polarizing plates as it utilizes a PDLC panel, color filters, and a black matrix for partitioning color filters. This enables a display device having a higher luminance than a common liquid crystal display device including a planar backlight.

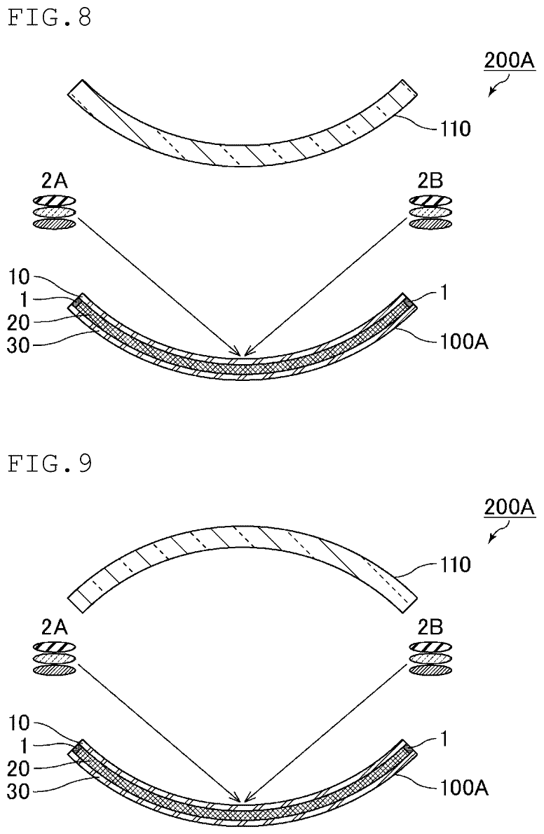

The display device 200A may further include a display panel disposed rearward of the back surface side of the liquid crystal panel 100A. FIG. 8 is a schematic cross-sectional view of an example display device according to Embodiment 1 including a display panel disposed rearward of the back surface side of the liquid crystal panel. FIG. 9 is a schematic cross-sectional view of another example display device according to Embodiment 1 including a display panel disposed rearward of the back surface side of the liquid crystal panel.

The display panel 110 may be curved such that the center thereof protrudes toward the liquid crystal panel 100A side. The display panel 110 may also be curved such that the center thereof protrudes toward the side opposite to the liquid crystal panel 100A side.

The display panel 110 may be a display panel that displays images. Since the liquid crystal panel 100A is a see-through display, various expressions can be made by displaying images on the display panel disposed rearward of the back surface side and superimposing thereon images displayed on the liquid crystal panel 100A.

The display panel 110 may be, for example, a liquid crystal panel including a pair of substrates and a liquid crystal layer sandwiched between the pair of substrates. When the display panel 110 is a liquid crystal panel, the display panel 110 may further include a backlight disposed rearward of the back surface side. The display panel 110 may also be a self-luminous panel such as a light-emitting diode (LED) panel.

The display device 200A can be used as, for example, a television, digital signage, a shop window, lighting equipment, a dimmable panel, an amusement device, an information sign, or a mobile device.

### Embodiment 2

In Embodiment 2, a case is described where a liquid crystal panel 100B is curved such that the center thereof protrudes toward the light source 2 side. Embodiment 2 is the same as Embodiment 1, except that the direction in which the liquid crystal panel is curved is different. Thus, description of the same components is omitted.

The display device according to Embodiment 2 includes a liquid crystal panel including a pair of substrates and a polymer dispersed liquid crystal layer held between the pair of substrates; and a light source disposed on a back surface side of the liquid crystal panel, with a space between the light source and the liquid crystal panel. The liquid crystal panel is curved such that a center in a curving direction along a surface of the liquid crystal panel protrudes toward the back surface side of the liquid crystal panel relative to two end portions in the curving direction. The light source is disposed, in a plan view, along at least one of the two end portions of the liquid crystal panel extending in a direction perpendicular to the curving direction. The liquid crystal panel has a curvature of 1/(W₁×40) or more and 1/(W₁×1.25) or less, where W₁ (unit: cm) is a length of the liquid crystal panel along the curving direction.

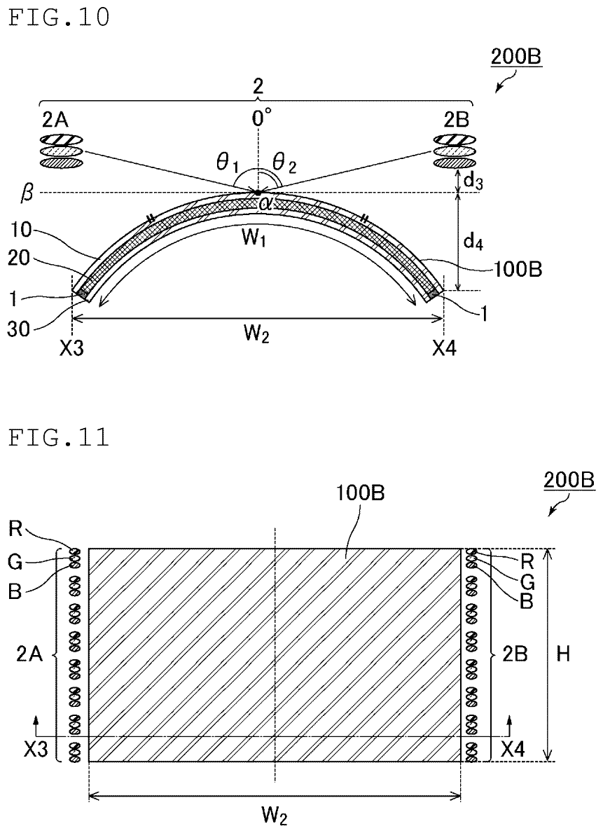

FIG. 10 is a schematic cross-sectional view of an example display device according to Embodiment 2. FIG. 11 is a schematic plan view of the display device in FIG. 10. FIG. 10 is a cross-sectional view taken in the curving direction along line X3-X4 shown in FIG. 11. Also in Embodiment 2, with the curvature of the liquid crystal panel set to 1/(W₁×40) or more and 1/(W₁×1.25) or less, the surface reflectance at the center of the liquid crystal panel 100B can be reduced and the luminance of the display device can be increased. The curvature of the liquid crystal panel 100B may be set to be within the same range as the curvature of the liquid crystal panel 100A described in Embodiment 1. The irradiation angle of light from the light source 2 that is incident on the center of the liquid crystal panel 100B may be set to be within the same range as the irradiation angle of light from the light source 2 that is incident on the center of the liquid crystal panel 100A as described in Embodiment 1.

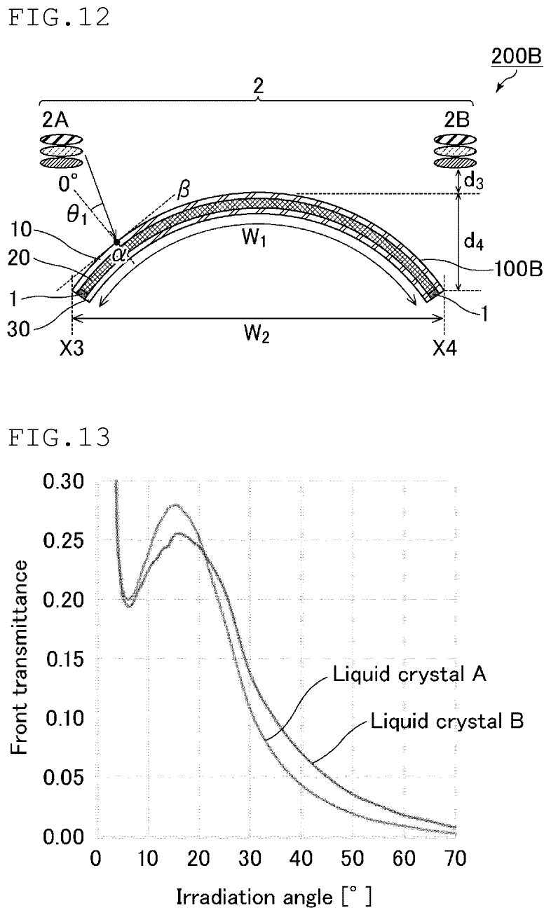

FIG. 12 is a schematic cross-sectional view illustrating the irradiation angle relative to a predetermined position from an end portion of the liquid crystal panel in Embodiment 2 in which the liquid crystal panel is bent toward the back surface side. An arbitrary point α on the surface of the liquid crystal panel 100B on the back surface side in a cross section taken along the curving direction is set as a predetermined position from an end portion of the liquid crystal panel, and the direction perpendicular on the light source 2 side to the tangent line β at the point α is set as the 0° direction. When the first light source 2A and the second light source 2B are disposed at the two ends of the liquid crystal panel 100B, the irradiation angle refers to the irradiation angle θ₁ or θ₂, whichever is of the light source closer to the point α. Since the light source 2 is disposed on the back surface side of the liquid crystal panel 100B, with a space between the light source 2 and the liquid crystal panel 100B, the angles θ₁ and θ₂ are both more than 0° and less than 90°.

The irradiation angle relative to the ¼ position and the ⅛ position from an end portion of the liquid crystal panel 100B may be set to be within the same range as the irradiation angle relative to the ¼ position and the ⅛ position from an end portion of the liquid crystal panel 100A as described in Embodiment 1.

In Embodiment 2, the irradiation angle of light from the light source 2 that is incident on the center of the liquid crystal panel 100B is preferably 60.0° or more and 70.0° or less.

The length W₁ along the curving direction of the liquid crystal panel 100B, the width W₂ of the liquid crystal panel 100B, and the height H of the liquid crystal panel 100B may be set to within the respective ranges as those for the liquid crystal panel 100A described in Embodiment 1.

A distance d₃ from the light source 2 to the liquid crystal panel 100B is preferably 1/20 or more and ⅕ or less of the length W₁ of the liquid crystal panel 100B. With the distance d₃ within the range above, the difference in luminance between the center and the end portions of the liquid crystal panel can be small. The distance d₃ refers to a length of a line extending perpendicularly from a tangent line toward the light source 2, the tangent line at a point on the surface of the liquid crystal panel 100B on the back surface side that protrudes farthest toward the back surface side.

The d₃ is appropriately selected according to the size and intended use of the display device and is 1 cm or more and 15 cm or less, for example. When the display device 200B is used for an amusement device, the d₃ is preferably 5 cm or more and 10 cm or less. In the case of the later-described FSC driving, the d₃ is preferably 5 cm or more to allow the display device to achieve a sufficient luminance.

The depth d₄ of the liquid crystal panel 100B may be 1/320 or more and 1/10 or less of the length W₁ of the liquid crystal panel along the curving direction. The d₄ is the maximum distance of a line extending perpendicularly from a straight line toward the surface of the liquid crystal panel 100B on the back surface side, the straight line connecting the two ends perpendicular to the curving direction of the liquid crystal panel 100B. The depth d₄ of the liquid crystal panel 100B may be 0.1 cm or more and (W₂×0.1) cm or less.

The display device 200B according to Embodiment 2 can also be FSC-driven. As in Embodiment 1, the display device 200B may further include a display panel disposed rearward of the back surface side of the liquid crystal panel 100B.

### EXAMPLES

The present disclosure is described in more detail based on examples. The present invention is not limited to the examples.

Display devices according to examples and comparative examples are each a reverse mode display device that includes a liquid crystal panel including a polymer dispersed liquid crystal layer (hereinbelow, the panel is referred to as a PDLC panel) and light sources and provides color display by FSC driving. The light sources included red, green, and blue LEDs disposed on two opposing short sides of the liquid crystal panel.

FIG. 13 is a graph of angle dependence of the polymer dispersed liquid crystal layers used in examples and comparative examples. The polymer dispersed liquid crystal (PDLC) material used for the polymer dispersed liquid crystal layers contained no chiral agent but contained liquid crystal components, a polymerizable liquid crystal compound, and a polymerization initiator. The liquid crystal components used for examination had an anisotropy of refractive index Δn of 0.18, an anisotropy of dielectric constant Δε of 20, a rotational viscosity γ of 170 mPa·s (liquid crystal A), or had an anisotropy of refractive index Δn of 0.22, an anisotropy of dielectric constant Δε of 20, and a rotational viscosity γ of 350 mPa·s (liquid crystal B). The polymerizable liquid crystal compound was one curable by ultraviolet irradiation, and was added such that the amount thereof was 9% by weight relative to the weight of the liquid crystal components. When the liquid crystal components were of the liquid crystal A, the polymerization initiator was added such that the amount thereof was 10% by weight relative to the weight of the polymerizable liquid crystal compound. When the liquid crystal components were of the liquid crystal B, the polymerization initiator was added such that the amount thereof was 7% by weight relative to the weight of the polymerizable liquid crystal compound.

### Comparative Examples 1 to 3

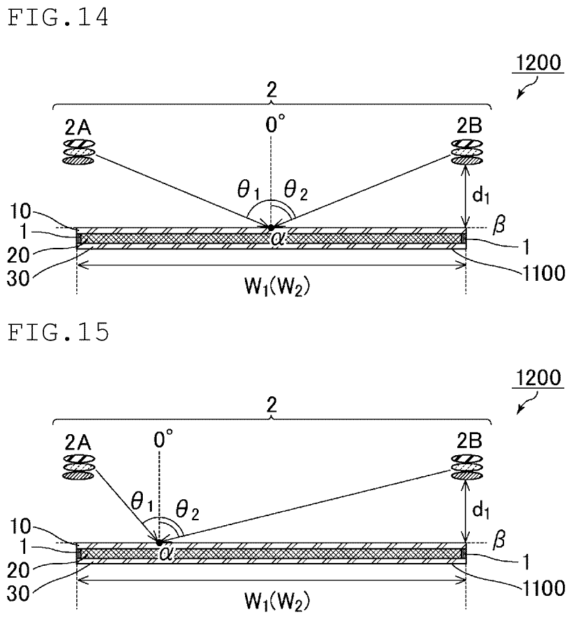

The liquid crystal panels of Comparative Examples 1 to 3 were 19-inch PDLC panels having no curvature. The liquid crystal panels each had a length W₁ of 40 cm, and a distance d₁ between the liquid crystal panel and the light sources of 10 cm. FIG. 14 is a schematic cross-sectional view illustrating the irradiation angle relative to the center of the liquid crystal panel in Comparative Example 1. In Comparative Examples 1 to 3, the light sources were disposed such that the irradiation angles (θ₁=θ₂) at the centers of the liquid crystal panels were respectively 63.4°, 76.0°, and 68.2°. FIG. 15 is a schematic cross-sectional view illustrating the irradiation angle relative to a predetermined position from an end portion of the liquid crystal panel in Comparative Example 1.

### Comparative Example 4

The liquid crystal panel in the display device according to Comparative Example 4 was a PDLC panel that was curved such that the center in the curving direction along the surface of the liquid crystal panel protruded toward the front surface side of the liquid crystal panel relative to the two end portions in the curving direction. In the PDLC panel used in Comparative Example 4, the irradiation angle of the light sources was the same as in Comparative Example 1, and the curvature of the PDLC panel was changed as shown in Table 2.

### Examples 1 to 9

The display devices according to Examples 1 to 9 were specific examples of Embodiment 1, and each included a PDLC panel that was curved such that the center in the curving direction along the surface of the liquid crystal panel protruded toward the front surface side of the liquid crystal panel relative to the two end portions in the curving direction. The liquid crystal panel had a length W₁ of 40 cm, and a distance d₁ between the liquid crystal panel and the light sources of 10 cm. In the PDLC panels used in Examples 1 to 9, the irradiation angle of the light sources was the same as in Comparative Example 1, and the curvatures of the PDLC panels were changed as shown in Table 2. For example, in Example 1, the liquid crystal panel had a depth d₂ of 2 cm, and a lateral width W₂ of 39.7 cm.

### Examples 10 to 18

The display devices according to Examples 10 to 18 are specific examples of Embodiment 1, and each included as its liquid crystal panel a PDLC panel that was curved such that the center in the curving direction along the surface of the liquid crystal panel protruded toward the front surface side of the liquid crystal panel relative to the two end portions in the curving direction. The liquid crystal panel had a length W₁ of 40 cm, and a distance d₁ between the liquid crystal panel and the light sources of 5 cm. In the PDLC panels used in Examples 10 to 18, the irradiation angle of the light sources was the same as in Comparative Example 2, and the curvature of the PDLC panel was changed as shown in Table 3.

### Examples 19 to 24

The display devices according to Examples 19 to 24 are specific examples of Embodiment 1, and each included as its liquid crystal panel a PDLC panel that was curved such that the center in the curving direction along the surface of the liquid crystal panel protruded toward the front surface side of the liquid crystal panel relative to the two end portions in the curving direction. The liquid crystal panel had a length W₁ of 15 cm, and a distance d₁ between the liquid crystal panel and the light sources of 3 cm. In the PDLC panels used in Examples 19 to 24, the irradiation angle of the light sources was the same as in Comparative Example 3, and the curvature of the PDLC panel was changed as shown in Table 4.

### Examples 25 to 32

The display devices according to Examples 25 to 32 are specific examples of Embodiment 2, and each included as its liquid crystal panel a PDLC panel that was curved such that the center in the curving direction along the surface of the liquid crystal panel protruded toward the back surface side of the liquid crystal panel relative to the two end portions in the curving direction. The liquid crystal panel had a length W₁ of 40 cm, and a distance d₁ between the liquid crystal panel and the light sources of 10 cm. In the PDLC panels used in Examples 25 to 32, the irradiation angle of the light sources was the same as in Comparative Example 1, and the curvature of the PDLC panel was changed as shown in Table 5.

### Examples 33 to 38

The display devices according to Examples 33 to 38 are specific examples of Embodiment 2, and each included as its liquid crystal panel a PDLC panel that was curved such that the center in the curving direction along the surface of the liquid crystal panel protruded toward the back surface side of the liquid crystal panel relative to the two end portions in the curving direction. The liquid crystal panel had a length W₁ of 15 cm, and a distance d₁ between the liquid crystal panel and the light sources of 3 cm. In the PDLC panels used in Examples 33 to 38, the irradiation angle of the light sources was the same as in Comparative Example 3, and the curvature of the PDLC panel was changed as shown in Table 6.

### <Examination on Rate of Increase in Luminance>

The luminance during white display was calculated for the liquid crystal panels in Examples 1 to 38 and Comparative Examples 1 to 4 based on the graph shown in FIG. 13. The luminance was calculated using the measurements obtained with “LCD5200” available from Otsuka Electronics Co., Ltd. The state “during white display” is a case where, for example, a voltage of 7.0 V was applied to the polymer dispersed liquid crystal layer. The results are shown in the following Table 2 to Table 6. The “Rate of increase in luminance” in each table was determined by taking the luminance values of the liquid crystal panels in Comparative Example 1, Comparative Example 2, and Comparative Example 3 as 1.00 respectively in Table 2 to Table 4, by taking the luminance of the liquid crystal panel in Comparative Example 1 as 1.00 in Table 5, and by taking the luminance of the liquid crystal panel in Comparative Example 3 as 1.00 in Table 6.

For Examples 25 to 38 using the liquid crystal panel protruding toward the back surface side, the irradiation angle θ1 at the ¼ position from the end portion of the liquid crystal panel with the first light source 2A disposed rearward thereof as shown in FIG. 12 is shown in Table 5 and Table 6.

The rates of increase in luminance shown in Table 5 and Table 6 are values calculated using only light from the light source (first light source 2A) closer to the ¼ position.

TABLE 2

| | | Comparative | Comparative | | | | |
|---|---|---|---|---|---|---|---|
| | | Example 1 | Example 4 | Example 1 | Example 2 | Example 3 | Example 4 |
| Curvature of liquid crystal panel | | 0 | 1/4000 | 1/1000 | 1/550 | 1/350 | 1/265 |
| Curvature of liquid crystal panel | | — | 1/(W₁ × 100) | 1/(W₁ × 25) | 1/(W₁ × 13.75) | 1/(W₁ × 8.75) | 1/(W₁ × 6.63) |
| (length W₁ of liquid crystal panel = 40 cm) | | | | | | | |
| Irradiation angle relative to center | | 63.4 | 63.3 | 63.0 | 62.6 | 62.1 | 61.7 |
| of liquid crystal panel [°] | | | | | | | |
| Rate of increase in | Liquid crystal A | 1.00 | 1.01 | 1.05 | 1.10 | 1.15 | 1.20 |
| luminance [times] | Liquid crystal B | 1.00 | 1.01 | 1.03 | 1.06 | 1.09 | 1.12 |

| | | Example 5 | Example 6 | Example 7 | Example 8 | Example 9 |
|---|---|---|---|---|---|---|
| Curvature of liquid crystal panel | | 1/200 | 1/150 | 1/100 | 1/80 | 1/50 |
| Curvature of liquid crystal panel | | 1/(W₁ × 5) | 1/(W₁ × 3.75) | 1/(W₁ × 2.5) | 1/(W₁ × 2) | 1/(W₁ × 1.25) |
| (length W₁ of liquid crystal panel = 40 cm) | | | | | | |
| Irradiation angle relative to center | | 61.2 | 60.4 | 58.9 | 57.8 | 54.4 |
| of liquid crystal panel [°] | | | | | | |
| Rate of increase in | Liquid crystal A | 1.27 | 1.35 | 1.53 | 1.67 | 2.12 |
| luminance [times] | Liquid crystal B | 1.15 | 1.20 | 1.36 | 1.49 | 1.89 |

| | | Comparative | | | | | |
|---|---|---|---|---|---|---|---|
| | | Example 2 | Example 10 | Example 11 | Example 12 | Example 13 | Example 14 |
| Curvature of liquid crystal panel | | 0 | 1/1000 | 1/550 | 1/350 | 1/265 | 1/200 |
| Curvature of liquid crystal panel | | — | 1/(W₁ × 25) | 1/(W₁ × 13.75) | 1/(W₁ × 8.75) | 1/(W₁ × 6.63) | 1/(W₁ × 5) |
| (length W₁ of liquid crystal panel = 40 cm) | | | | | | | |
| Irradiation angle relative to center | | 76.0 | 75.4 | 75.0 | 74.4 | 73.9 | 73.3 |
| of liquid crystal panel [°] | | | | | | | |
| Rate of increase in | Liquid crystal A | 1.00 | 1.05 | 1.10 | 1.15 | 1.20 | 1.27 |
| luminance [times] | Liquid crystal B | 1.00 | 1.07 | 1.12 | 1.19 | 1.25 | 1.33 |

| | | Example 15 | Example 16 | Example 17 | Example 18 |
|---|---|---|---|---|---|
| Curvature of liquid crystal panel | | 1/150 | 1/100 | 1/80 | 1/50 |
| Curvature of liquid crystal panel | | 1/(W₁ × 3.75) | 1/(W₁ × 2.5) | 1/(W₁ × 2) | 1/(W₁ × 1.25) |
| (length W₁ of liquid crystal panel = 40 cm) | | | | | |
| Irradiation angle relative to center | | 72.4 | 70.6 | 69.3 | 65.3 |
| of liquid crystal panel [°] | | | | | |
| Rate of increase in | Liquid crystal A | 1.36 | 1.54 | 1.78 | 2.79 |
| luminance [times] | Liquid crystal B | 1.44 | 1.65 | 1.90 | 2.84 |

| | | Comparative | | | | | | |
|---|---|---|---|---|---|---|---|---|
| | | Example 3 | Example 19 | Example 20 | Example 21 | Example 22 | Example 23 | Example 24 |
| Curvature of liquid crystal panel | | 0 | 1/400 | 1/200 | 1/100 | 1/75 | 1/50 | 1/25 |
| Curvature of liquid crystal panel | | — | 1/(W₁ × 26.67) | 1/(W₁ × 13.33) | 1/(W₁ × 6.67) | 1/(W₁ × 5) | 1/(W₁ × 3.33) | 1/(W₁ × 1.67) |
| (length W₁ of liquid crystal | | | | | | | | |
| panel = 15 cm) | | | | | | | | |
| Irradiation angle relative to center | | 68.2 | 67.7 | 67.3 | 66.4 | 65.7 | 64.5 | 60.9 |
| of liquid crystal panel [°] | | | | | | | | |
| Rate of increase in | Liquid | 1.00 | 1.06 | 1.11 | 1.23 | 1.30 | 1.49 | 2.21 |
| luminance [times] | crystal A | | | | | | | |
| | Liquid | 1.00 | 1.05 | 1.10 | 1.20 | 1.27 | 1.40 | 1.77 |
| | crystal B | | | | | | | |

| | | Comparative | | | | |
|---|---|---|---|---|---|---|
| | | Example 1 | Example 25 | Example 26 | Example 27 | Example 28 |
| Curvature of liquid crystal panel | | 0 | 1/800 | 1/385 | 1/250 | 1/200 |
| Curvature of liquid crystal panel | | — | 1/(W₁ × 20) | 1/(W₁ × 9.63) | 1/(W₁ × 6.25) | 1/(W₁ × 5) |
| (length W₁ of liquid crystal panel = | | | | | | |
| 40 cm) | | | | | | |
| Irradiation angle relative to center | | 63.4 | 63.4 | 63.4 | 63.4 | 63.4 |
| of liquid crystal panel [°] | | | | | | |
| Irradiation angle relative to ¼ | | 45.0 | 44.5 | 44.0 | 43.5 | 43.1 |
| position from end of liquid crystal | | | | | | |
| panel [°] | | | | | | |
| Rate of increase in | Liquid crystal A | 1.00 | 1.05 | 1.10 | 1.15 | 1.18 |
| luminance [times] | Liquid crystal B | 1.00 | 1.04 | 1.08 | 1.12 | 1.15 |

| | | Example 29 | Example 30 | Example 31 | Example 32 |
|---|---|---|---|---|---|
| Curvature of liquid crystal panel | | 1/150 | 1/100 | 1/80 | 1/50 |
| Curvature of liquid crystal panel | | 1/(W₁ × 3.75) | 1/(W₁ × 2.5) | 1/(W₁ × 2) | 1/(W₁ × 1.25) |
| (length W₁ of liquid crystal panel = | | | | | |
| 40 cm) | | | | | |
| Irradiation angle relative to center | | 63.4 | 63.4 | 63.3 | 63.2 |
| of liquid crystal panel [°] | | | | | |
| Irradiation angle relative to ¼ | | 42.6 | 41.8 | 41.2 | 40.2 |
| position from end of liquid crystal | | | | | |
| panel [°] | | | | | |
| Rate of increase in | Liquid crystal A | 1.23 | 1.31 | 1.36 | 1.47 |
| luminance [times] | Liquid crystal B | 1.19 | 1.26 | 1.30 | 1.38 |

| | | Comparative | | | | | | |
|---|---|---|---|---|---|---|---|---|
| | | Example 3 | Example 33 | Example 34 | Example 35 | Example 36 | Example 37 | Example 38 |
| Curvature of liquid crystal panel | | 0 | 1/600 | 1/300 | 1/100 | 1/75 | 1/50 | 1/30 |
| Curvature of liquid crystal panel | | — | 1/(W₁ × 40) | 1/(W₁ × 20) | 1/(W₁ × 6.67) | 1/(W₁ × 5) | 1/(W₁ × 3.33) | 1/(W₁ × 2) |
| (length W₁ of liquid crystal panel = | | | | | | | | |
| 15 cm) | | | | | | | | |
| Irradiation angle relative to center | | 68.2 | 68.2 | 68.2 | 68.2 | 68.2 | 68.1 | 68.0 |
| of liquid crystal panel [°] | | | | | | | | |
| Irradiation angle relative to ¼ | | 51.3 | 50.9 | 50.4 | 48.5 | 47.5 | 45.6 | 41.5 |
| position from end of liquid crystal | | | | | | | | |
| panel [°] | | | | | | | | |
| Rate of increase in | Liquid crystal A | 1.00 | 1.03 | 1.07 | 1.27 | 1.38 | 1.61 | 2.23 |
| luminance [times] | Liquid crystal B | 1.00 | 1.03 | 1.05 | 1.21 | 1.30 | 1.47 | 1.94 |

As shown in Table 2, in Example 5 in which the curvature of the liquid crystal panel was 1/200, the front transmittance of the liquid crystal panel was higher than that in Comparative Example 1 in which the liquid crystal panel was not curved, by 1.27 times in the case of the liquid crystal A and by 1.15 times in the case of the liquid crystal B. In Example 7 in which the curvature of the liquid crystal panel was 1/100, the front transmittance of the liquid crystal panel was higher than that in Comparative Example 1 by 1.53 times in the case of the liquid crystal A and by 1.36 times in the case of the liquid crystal B. Also in Example 7, the irradiation angle of one of the light sources with the LEDs was reduced by 4.6° at the center of the panel, and by 3.5° on average at a point 10 cm from the end of the panel.

As shown in Table 3 to Table 6, also when the irradiation angle relative to the center of the liquid crystal panel was changed, as the curvature of the liquid crystal panel was increased, the front transmittance of the liquid crystal panel increased more both in the cases of the liquid crystal A and the liquid crystal B than those in comparative examples. Specifically, when the curvature of the liquid crystal panel was set to 1/(W₁×13.75) or more and 1/(W₁×1.25) or less and the irradiation angle relative to the center of the liquid crystal panel was set to 54.0° or more and 75.0° or less, the luminance at the center of the liquid crystal panel was increased by 10% or more in the case of the liquid crystal A and by 5% or more in the case of the liquid crystal B.

As shown in Table 3 to Table 6, when the curvature of the liquid crystal panel was set to 1/(W₁×5) or more and 1/(W₁×1.25) or less and the irradiation angle relative to the center of the liquid crystal panel was set to 54.0° or more and 73.5° or less, the luminance at the center of the liquid crystal panel was increased by 15% or more both in the cases of the liquid crystal A and the liquid crystal B. In particular, the luminance at the center of the liquid crystal panel was increased by 27% or more in the case of the liquid crystal A in Tables 2 to 4.

As shown in Table 3 to Table 6, when the curvature of the liquid crystal panel was set to 1/(W₁×2.5) or more and 1/(W₁×1.25) or less and the irradiation angle relative to the center of the liquid crystal panel was set to 54.0° or more and 71.0° or less, the luminance at the center of the liquid crystal panel was increased by 20% or more both in the cases of the liquid crystal A and the liquid crystal B. In particular, the luminance at the center of the liquid crystal panel was increased by 53% or more in the case of the liquid crystal A in Tables 2 to 4.

As shown in Table 3 to Table 6, the curvature of the liquid crystal panel was set to 1/(W₁×2) or more and 1/(W₁×1.25) or less and the irradiation angle relative to the center of the liquid crystal panel was set to 54.0° or more and 70.0° or less, the luminance at the center of the liquid crystal panel was increased by 30% or more both in the cases of the liquid crystal A and the liquid crystal B. In particular, the luminance at the center of the liquid crystal panel was increased by 67% or more in the case of the liquid crystal A in Tables 2 to 4.

### <Examination on Luminance Unevenness of Liquid Crystal Panel>

The luminance at the center of the liquid crystal panel in each of Examples 1 to 9 and Comparative Examples 1 and 4 relative to the luminance at the ⅛ position from the end portion of the panel in the case of the liquid crystal A was measured. The results are shown in Table 7. The ⅛ position from the left end portion of the liquid crystal panel with the first light source 2A disposed rearward thereof was taken as the ⅛ position from the end portion of the liquid crystal panel. In Table 7, θ₁ and θ₂ are respectively irradiation angles of light from the first light source 2A and the second light source 2B that is incident on the ⅛ position from the end portion of the liquid crystal panel.

TABLE 7

| | | Compar- | Compar- | | | | |
|---|---|---|---|---|---|---|---|
| | | ative | ative | | | | |
| | | Example 1 | Example 4 | Example 1 | Example 2 | Example 3 | Example 4 |
| Curvature of liquid crystal panel | | 0 | 1/4000 | 1/1000 | 1/550 | 1/350 | 1/265 |
| Curvature of liquid crystal panel | | — | 1/ | 1/ | 1/ | 1/ | 1/ |
| (length W₁ of liquid crystal panel = 40 cm) | | | (W₁ × 100) | (W₁ × 25) | (W₁ × 13.75) | (W₁ × 8.75) | (W₁ × 6.63) |
| Center of liquid crystal | Irradiation angle θ₁ = θ₂ [°] | 63.4 | 63.3 | 63.0 | 62.6 | 62.1 | 61.7 |
| panel (½ position from end | | | | | | | |
| of liquid crystal panel) | Front transmittance at irradiation | 0.013 | 0.013 | 0.013 | 0.014 | 0.015 | 0.015 |
| | angle θ₁ and front transmittance | | | | | | |
| | at θ₂ in total | | | | | | |
| ⅛ Position from end of | Irradiation angle θ₁ [°] | 26.6 | 26.7 | 27.2 | 27.8 | 28.4 | 29.0 |
| liquid crystal panel | Front transmittance at irradiation | 0.1578 | 0.1559 | 0.1486 | 0.1406 | 0.1306 | 0.1218 |
| | angle θ₁ | | | | | | |
| | Irradiation angle θ₂ [°] | 74.1 | 73.8 | 73.1 | 72.2 | 71.2 | 70.3 |
| | Front transmittance at irradiation | 0.002 | 0.002 | 0.002 | 0.003 | 0.003 | 0.003 |
| | angle θ₂ | | | | | | |
| | Front transmittance at irradiation | 0.160 | 0.158 | 0.151 | 0.143 | 0.133 | 0.125 |
| | angle θ₁ and front transmittance | | | | | | |
| | at θ₂ in total | | | | | | |

| | | | | | | |
|---|---|---|---|---|---|---|
| Luminance at center of liquid crystal panel | 12.5 | 12.2 | 11.2 | 10.2 | 9.0 | 8.1 |
| relative to luminance at ⅛ position from | | | | | | |
| end of liquid crystal panel [times] | | | | | | |

| | | Example 5 | Example 6 | Example 7 | Example 8 | Example 9 |
|---|---|---|---|---|---|---|
| Curvature of liquid crystal panel | | 1/200 | 1/150 | 1/100 | 1/80 | 1/50 |
| Curvature of liquid crystal panel | | 1/ | 1/ | 1/ | 1/ | 1/ |
| (length W₁ of liquid crystal panel = 40 cm) | | (W₁ × 5) | (W₁ × 3.75) | (W₁ × 2.5) | (W₁ × 2) | (W₁ × 1.25) |
| Center of liquid crystal | Irradiation angle θ₁ = θ₂ [°] | 61.2 | 60.4 | 58.9 | 57.8 | 54.4 |
| panel (½ position from end | | | | | | |
| of liquid crystal panel) | Front transmittance at irradiation | 0.016 | 0.017 | 0.020 | 0.021 | 0.027 |
| | angle θ₁ and front transmittance | | | | | |
| | at θ₂ in total | | | | | |
| ⅛ Position from end of | Irradiation angle θ₁ [°] | 29.8 | 30.9 | 33.0 | 34.5 | 39.0 |
| liquid crystal panel | Front transmittance at irradiation | 0.1100 | 0.1002 | 0.0834 | 0.0709 | 0.0479 |
| | angle θ₁ | | | | | |
| | Irradiation angle θ₂ [°] | 69.1 | 67.4 | 64.1 | 61.5 | 53.9 |
| | Front transmittance at irradiation | 0.003 | 0.004 | 0.006 | 0.008 | 0.014 |
| | angle θ₂ | | | | | |
| | Front transmittance at irradiation | 0.113 | 0.104 | 0.089 | 0.079 | 0.062 |
| | angle θ₁ and front transmittance | | | | | |
| | at θ₂ in total | | | | | |

| | | | | | |
|---|---|---|---|---|---|
| Luminance at center of liquid crystal panel | 7.0 | 6.0 | 4.6 | 3.7 | 2.3 |
| relative to luminance at ⅛ position from | | | | | |
| end of liquid crystal panel [times] | | | | | |

As shown in Table 7, the ratio of the luminance at the center of the liquid crystal panel to the luminance at the ⅛ position from the end portion of the liquid crystal panel was 12.5 in Comparative Example 1 in which the liquid crystal panel was not curved, whereas the ratio was 7.0 in Example 5 in which the curvature of the liquid crystal panel was 1/200, and the ratio was 4.6 in Example 7 in which the curvature of the liquid crystal panel was 1/100. These results demonstrate that increasing the curvature of the liquid crystal panel reduces the luminance unevenness across the whole liquid crystal panel.

The following Table 8 shows the irradiation angle θ₁ of the first light source 2A relative to the ⅛ position, ¼ position, ½ position, ¾ position, and ⅞ position from the left end portion of the liquid crystal panel with the first light source 2A disposed rearward thereof, the irradiation angle θ₂ of the second light source 2B disposed rearward of the right end portion of the liquid crystal panel, and the average of θ₁ and θ₂ in each of Comparative Example 1 and Examples 1 and 5.

TABLE 8

| | | Comparative | | |
|---|---|---|---|---|
| | | Example 1 | Example 1 | Example 5 |
| Curvature of liquid crystal panel | | 0 | 1/(W₁ × 25) | 1/(W₁ × 5) |
| (length W₁ of liquid crystal panel = 40 cm) | | | | |
| ⅛ Position from end of | Irradiation angle θ₁ [°] | 26.6 | 27.2 | 29.8 |
| liquid crystal panel | Irradiation angle θ₂ [°] | 74.1 | 73.1 | 69.1 |
| | Average of θ₁ and θ₂ [°] | 50.4 | 50.2 | 49.5 |
| ¼ Position from end of | Irradiation angle θ₁ [°] | 45 | 45.1 | 45.7 |
| liquid crystal panel | Irradiation angle θ₂ [°] | 71.6 | 70.7 | 67.4 |
| | Average of θ₁ and θ₂ [°] | 58.3 | 57.9 | 56.6 |
| ½ Position from end of | Irradiation angle θ₁ [°] | 63.4 | 63 | 61.2 |
| liquid crystal panel (center) | Irradiation angle θ₂ [°] | 63.4 | 63 | 61.2 |
| | Average of θ₁ and θ₂ [°] | 63.4 | 63 | 61.2 |
| ¾ Position from end of | Irradiation angle θ₁ [°] | 71.6 | 70.7 | 67.4 |
| liquid crystal panel | Irradiation angle θ₂ [°] | 45 | 45.1 | 45.7 |
| | Average of θ₁ and θ₂ [°] | 58.3 | 57.9 | 56.6 |
| ⅞ Position from end of | Irradiation angle θ₁ [°] | 74.1 | 73.1 | 69.1 |
| liquid crystal panel | Irradiation angle θ₂ [°] | 26.6 | 27.2 | 29.8 |
| | Average of θ₁ and θ₂ [°] | 50.4 | 50.2 | 49.5 |

| | | | |
|---|---|---|---|
| Difference between center (½) and ⅛ position [°] | 13.0 | 12.8 | 11.7 |

As shown in Table 8, as the curvature of the liquid crystal panel increased, the difference in irradiation angle (average of θ₁ and θ₂) between the ⅛ position from the end portion of the liquid crystal panel and the center decreased. This means that reducing the difference in average of θ₁ and θ₂ between the center and end portion of the liquid crystal panel also enables reduction of the luminance difference between the center and end portion of the liquid crystal panel.

### REFERENCE SIGNS LIST

1: sealing material
2: light source
2A: first light source
2B: second light source
10, 20: substrate
11, 21: base material
12, 22: electrode
13, 23: alignment film
30: polymer dispersed liquid crystal layer
31: polymer network
32: liquid crystal component
100A, 100B, 1100: liquid crystal panel
110: display panel
200A, 200B, 1200: display device

What is claimed is:

1. A display device comprising:
a liquid crystal panel including a pair of substrates and a polymer dispersed liquid crystal layer held between the pair of substrates; and
a light source disposed on a back surface side of the liquid crystal panel, with a space between the light source and the liquid crystal panel,
the liquid crystal panel being curved such that a center in a curving direction along a surface of the liquid crystal panel protrudes toward a front surface side or the back surface side of the liquid crystal panel relative to two end portions in the curving direction,
the light source being disposed, in a plan view, along at least one of the two end portions of the liquid crystal panel extending in a direction perpendicular to the curving direction,
the liquid crystal panel having a curvature of 1/(W₁×40) or more and 1/(W₁×1.25) or less, where W₁ (unit: cm) is a length of the liquid crystal panel along the curving direction.

2. The display device according to claim 1,
wherein the liquid crystal panel being curved such that the center in the curving direction along the surface of the liquid crystal panel protrudes toward the front surface side of the liquid crystal panel relative to the two end portions in the curving direction.

3. The display device according to claim 1,
wherein the liquid crystal panel being curved such that the center in the curving direction along the surface of the liquid crystal panel protrudes toward the back surface side of the liquid crystal panel relative to the two end portions in the curving direction.

4. The display device according to claim 1,
wherein the light source is configured to emit light in an oblique direction relative to a surface of the liquid crystal panel.

5. The display device according to claim 1,
wherein an irradiation angle of light from the light source that is incident on the center of the liquid crystal panel is 54.0° or more and 76.0° or less.

6. The display device according to claim 5,
wherein the liquid crystal panel has a curvature of 1/(W₁×25) or more and 1/(W₁×1.25) or less.

7. The display device according to claim 3,
wherein an irradiation angle of light from the light source that is incident on the center of the liquid crystal panel is 60.0° or more and 70.0° or less.

8. The display device according to claim 1,
wherein the liquid crystal panel has a curvature of 1/(W₁×13.75) or more and 1/(W₁×1.25) or less, and
an irradiation angle of light from the light source that is incident on the center of the liquid crystal panel is 54.0° or more and 75.0° or less.

9. The display device according to claim 1,
wherein the liquid crystal panel has a curvature of 1/(W₁×5) or more and 1/(W₁×1.25) or less, and
an irradiation angle of light from the light source that is incident on the center of the liquid crystal panel is 54.0° or more and 73.5° or less.

10. The display device according to claim 1,
wherein the liquid crystal panel has a curvature of 1/(W₁×2.5) or more and 1/(W₁×1.25) or less, and
an irradiation angle of light from the light source that is incident on the center of the liquid crystal panel is 54.0° or more and 71.0° or less.

11. The display device according to claim 1,
wherein the liquid crystal panel has a curvature of 1/(W₁×2) or more and 1/(W₁×1.25) or less, and
an irradiation angle of light from the light source that is incident on the center of the liquid crystal panel is 54.0° or more and 70.0° or less.

12. The display device according to claim 1,
wherein a distance d₁ from the light source to the liquid crystal panel is 1/10 or more and ⅓ or less of the W₁.

13. The display device according to claim 1,
wherein the display device further comprises a display panel disposed rearward of a back surface side of the liquid crystal panel.

14. The display device according to claim 13,
wherein the display panel is curved to protrude toward the liquid crystal panel.

15. The display device according to claim 13,
wherein the display panel is curved to protrude toward a side opposite to the liquid crystal panel.
